(19) United States
(12) Patent Application Publication
(10) Pub. No.: US 2020/0133463 A1
(43) Pub. Date: Apr. 30, 2020

(54) DISPLAY METHOD AND APPARATUS OF ICON OF APPLICATION

(71) Applicant: Samsung Electronics Co., Ltd., Gyeonggi-do (KR)

(72) Inventors: Jianbing SUN, Tianjin (CN); Jingmeng GAN, Tianjin (CN); Mingde WANG, Tianjin (CN)

(73) Assignee: Samsung Electronics Co., Ltd.

(21) Appl. No.: 16/384,365

(22) Filed: Apr. 15, 2019

Related U.S. Application Data
(63) Continuation of application No. PCT/CN2018/111665, filed on Oct. 24, 2018.

(51) Int. Cl. G06F 3/0481; G06F 3/0484

(52) U.S. Cl. CPC G06F 3/04817; G06F 3/04842

(57) ABSTRACT

The present disclosure provides a display method and apparatus of an icon of an application, the method including: A) enabling the icon of the application to enter a dynamic mode; B) determining a display mode of the dynamic mode of the icon of the application; C) acquiring information corresponding to the determined display mode; and D) displaying the information on the icon of the application. According to the display method and apparatus of an icon of an application according to the exemplary embodiments of the present disclosure, after the icon of the application enters the dynamic mode, a display space of the icon of the application may be sufficiently utilized by acquiring the information corresponding to the display mode of the dynamic mode and displaying the acquired information on the icon of the application, and it is convenient for a user to view the information of the application.

### PRIORITY

This application is continuation of International Application No. PCT/CN2018/111665 filed on Oct. 24, 2018, the contents of which are incorporated herein by reference.

### TECHNICAL FIELD

The present disclosure relates to a technical field of interface display of a terminal, and more particularly, to method and apparatus of application icons.

### BACKGROUND

With development of network technology, communication technology and digital signal processing technology, various applications appear, and a user may enjoy services provided by applications by mounting various applications in a terminal. For example, the user may contact with others by mounting social type applications, may query vehicle arrival information by mounting traffic type applications, may do online shopping by mounting shopping type applications, and may further perform online fund transfer, credit card payment by mounting finance type applications, and so on. The applications often need to transmit various information, such as notification messages (for example, unread information, vehicle arrival information, logistics information of shopping, reminder information of credit card payment and the like), push messages (for example, news push and promotion information) and the like, to the user during the process of providing services for the user. At present, the user needs to pull down a pull-down notification bar of a desktop or enter a corresponding application to view the information, and such a viewing manner is inconvenient.

### SUMMARY

The purpose of the present disclosure aims to provide a display method and apparatus of an icon of an application to solve the problem that the manner of viewing information of applications in the prior art is inconvenient.

One aspect of the present disclosure provides a display method of an icon of an application, the method including: A) enabling the icon of the application to enter a dynamic mode; B) determining a display mode of the dynamic mode of the icon of the application; C) acquiring information corresponding to the determined display mode; and D) displaying the information on the icon of the application.

Alternatively, step D) in the method includes: displaying the information on the icon of the application in the determined display mode.

Alternatively, step D) in the method includes: determining the display manner according to the determined display mode or according to the determined display mode and the application and displaying the information on the icon of the application in the determined display manner.

Alternatively, step A) in the method includes: receiving a first setting operation of setting the icon of the application to a dynamic mode and setting the icon of the application to the dynamic mode in response to the first setting operation; or setting the icon of the application to the dynamic mode in response to a predetermined event.

Alternatively, step B) in the method includes: determining the display mode of the dynamic mode of the icon of the application according to a preset value of the display mode, a preset time and a predetermined event or a selection operation of a user for the display mode.

Alternatively, the determining of the display mode of the dynamic mode of the icon of the application according to the predetermined event in the method includes: detecting an event that occurred; determining whether a display mode associated with the occurred event exists among display modes of the dynamic mode of the icon of the application; and determining the display mode associated with the occurred event as the display mode of the dynamic mode of the icon of the application.

Alternatively, the event in the method includes at least one of: a system event and an event occurred in the application.

Alternatively, the display mode in the method includes at least one of: a message reminder mode, a push mode, a countdown mode and a custom mode. Information corresponding to the message reminder mode includes a real time message, information corresponding to the push mode includes a push message, information corresponding to the countdown mode includes time reminder information and the information corresponding to the custom mode includes the content set by the user for the application.

Alternatively, step D) in the method includes displaying latest acquired predetermined number of information, or displaying all of the acquired information by automatically scrolling, or displaying all of the acquired information by scrolling according to the user's operation, on the icon of the application.

Alternatively, step D) in the method includes: extracting a key content of the acquired information and displaying the key content on the icon of the application.

Alternatively, the method further includes: E) receiving a first predetermined operation performed on the icon of the application, and in response to the first predetermined operation, enlarge-displaying the icon of the application or previewing the information displayed on the icon of the application, wherein when the information displayed on the icon of the application is a plurality of pieces, the latest acquired information is previewed, or all of displayed information are previewed in an automatically scrolling manner, or all of displayed information are previewed in a scrolling manner according to the user's operation.

Alternatively, step E) in the method further includes displaying a widget for processing the previewed information.

Alternatively, the method further includes: F) receiving a second predetermined operation performed on the previewed information, and in response to the second predetermined operation, entering the application to view the previewed information.

Another aspect of the present disclosure provides a display apparatus of an icon of an application, the apparatus comprises a dynamic mode entering unit to enable the icon of the application to enter a dynamic mode; a display mode determining unit to determine a display mode of the dynamic mode of the icon of the application; an information acquiring unit to acquire information corresponding to the determined display mode; and an information display unit to display the information on the icon of the application.

Alternatively, in the apparatus, the information display unit displays the information on the icon of the application in the determined display mode.

Alternatively, in the apparatus, the information display unit determines the display manner according to the determined display mode or according to the determined display mode and the application, and displays the information on the icon of the application in the determined display manner.

Alternatively, in the apparatus, the dynamic mode entering unit receives a first setting operation of setting the icon of the application to a dynamic mode and setting the icon of the application to the dynamic mode in response to the first setting operation; or sets the icon of the application to the dynamic mode in response to a predetermined event.

Alternatively, in the apparatus, the display mode determining unit determines the display mode of the dynamic mode of the icon of the application according to a preset value of the display mode, a preset time and a predetermined event or a selection operation of a user for the display mode.

Alternatively, in the apparatus, the display mode determining unit detects an event that occurred, determines whether a display mode associated with the occurred event exists among display modes of the dynamic mode of the icon of the application, and determines the display mode associated with the occurred event to be the display mode of the dynamic mode of the icon of the application.

Alternatively, in the apparatus, the event includes at least one of a system event and an event occurred in the application.

Alternatively, in the apparatus, the display mode includes at least one of a message reminder mode, a push mode, a countdown mode and a custom mode. Information corresponding to the message reminder mode includes a real time message, information corresponding to the push mode includes a push message, information corresponding to the countdown mode includes time reminder information and the information corresponding to the custom mode includes the content set by the user for the application.

Alternatively, in the apparatus, the information display unit displays latest acquired predetermined number of information, or displays all of the acquired information by automatically scrolling, or displays all of the acquired information by scrolling according to the user's operation, on the icon of the application.

Alternatively, in the apparatus, the information display unit extracts a key content of the acquired information and displays the key content on the icon of the application.

Alternatively, the apparatus further includes a preview unit to receive a first predetermined operation performed on the icon of the application, and in response to the first predetermined operation, enlarge-display the icon of the application or preview the information displayed on the icon of the application, wherein when the information displayed on the icon of the application is a plurality of pieces, the latest acquired information is previewed, or all of displayed information are previewed in an automatically scrolling manner, or all of displayed information are previewed in a scrolling manner according to the user's operation.

Alternatively, in the apparatus, the preview unit displays a widget for processing the previewed information.

Alternatively, the apparatus further includes an application entering unit to receive a second predetermined operation performed on the previewed information, and in response to the second predetermined operation, enter the application to view the previewed information.

According to the display method and apparatus of an icon of an application of the exemplary embodiments of the present disclosure, after the icon of the application enters the dynamic mode, a display space of the icon of the application may be sufficiently utilized by acquiring the information corresponding to the display mode of the dynamic mode and displaying the acquired information on the icon of the application, and it is convenient for a user to view the information of the application.

Additional aspects and/or advantages of the present invention will be partially illustrated in the following description, and the rests will be apparent from description or obtained from the practice the present disclosure.

### BRIEF DESCRIPTION OF THE DRAWINGS

The above and other purposes, features and advantages will become more apparent from the following detailed description in conjunction with the accompanying drawings, in which:

FIG. 1 is a flow chart illustrating a display method of an icon of an application according to an exemplary embodiment of the present disclosure;

FIG. 2 illustrates a dynamic mode setting interface of an icon of an application according to an exemplary embodiment of the present disclosure;

FIG. 3 illustrates a setting interface of a display mode of a dynamic mode of an icon of an application according to an exemplary embodiment of the present disclosure;

FIG. 4 illustrates a setting interface for a user to set time reminder information with respect to an application according to an exemplary embodiment of the present disclosure;

FIG. 5 illustrates a setting interface for a user to set a content with respect to an application according to an exemplary embodiment of the present disclosure; and

FIG. 6 is a block diagram illustrating a display apparatus of an icon of an application according to an exemplary embodiment of the present disclosure.

### DETAILED DESCRIPTION

Embodiments of the present disclosure are described in detail below with reference to the accompanying drawings.

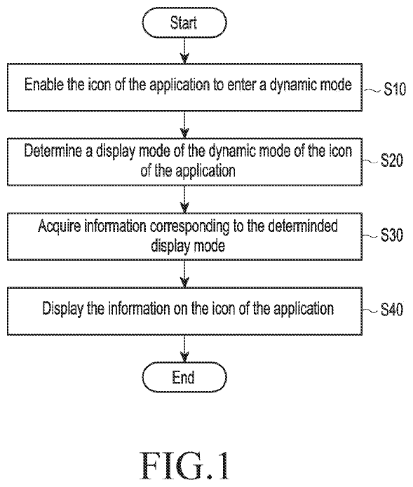

FIG. 1 is a flow chart illustrating a display method of an icon of application according to an exemplary embodiment of the present disclosure. The display method of an icon of an application according to an exemplary embodiment of the present disclosure may be applicable to various terminals which may display application icons, for example, a smart phone, a personal computer, a tablet computer, a game console, a digital multimedia player and the like.

Referring to FIG. 1, in step S10, an icon of an application is enabled to enter a dynamic mode. After the icon of the application according to an exemplary embodiment of the present disclosure enters the dynamic mode, the content displayed by the icon of the application may change.

Here, the icon of the application may be enabled to enter the dynamic mode according to an operation of the user or occurrence of a predetermined event.

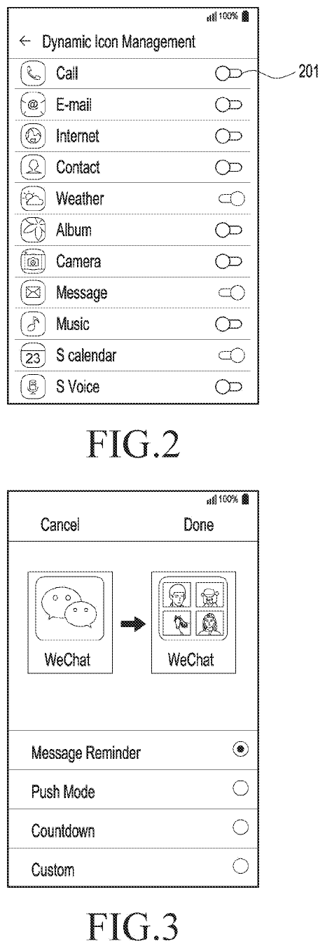

As an example, a first setting operation of setting an icon of an application to the dynamic mode may be received, and the icon of the application is set to the dynamic mode in response to the first setting operation. FIG. 2 illustrates a dynamic mode setting interface of an icon of an application according to an exemplary embodiment of the present disclosure. For example, a widget for entering the dynamic mode setting interface may be set in the system setting interface of the terminal. After the user operates the widget for entering the dynamic mode setting interface, the dynamic mode setting interface of the icon of the application as illustrated in FIG. 2 is entered. As illustrated in FIG. 2, a switch 201 for entering and exiting the dynamic mode is provided for each application in the dynamic mode setting interface. When the switch 201 is in an off state, the user may click the switch 201 to enable the switch 201 to enter a on state, thereby making the icon of the application corresponding to the switch 201 enter the dynamic mode. In FIG. 2, the user turns on the switch 201 of a weather application, a message application and an S calendar application, and the above three icons of applications are in the dynamic mode.

As an example, the icon of the application may be further set to the dynamic mode in response to a predetermined event. For example, an icon of a predetermined application may be set to the dynamic mode in response to a boot event. For example, the icon of the application may also be set to the dynamic mode in response to the application being run. For example, the icon of the application may be further set to the dynamic mode in response to a predetermined function of the application being executed (for example, a message push function of a certain application is turn on). For example, the icon of the application may be further set to the dynamic mode in response to a predetermined operation in the application being executed (for example, for participating in an activity of snapping up a mobile phone in a certain shopping application).

In step S20, a display mode of the dynamic mode of the icon of the application is determined. Here, the display mode may be used to determine a type and a specific display manner of information displayed in the icon of the application. In one embodiment, the display mode may include at least one of a message reminder mode, a push mode, a countdown mode and a custom mode. However, the present disclosure is not limited to hereto, and other display modes are also implementable.

Here, the display mode may be determined through various manners. For example, a display mode of the dynamic mode of the icon of the application may be determined according to a preset value of the display mode, a preset time, a predetermined event or a selection operation of the user for the display mode.

As an example, a display mode of the dynamic mode of the icon of the application may be determined according to the preset value of the display mode of the icon of the application. Here, the preset value of the display mode is used for indicating the display mode. In other words, the display mode is determined according to the display mode indicated by the preset value of the display mode that is preset with respect to the application. For example, the display mode of the dynamic mode of the icon of the application may be preset according to a type of the application. For example, for social type application (for example, a call application, a short message application, a WeChat application, a QQ application, a mail application and the like), the display mode of the dynamic mode of the icon of the application may be preset to be a message reminder mode; for news and information type application or shopping type application, the display mode of the dynamic mode of the icon of the application may be preset to be a push mode; and for fitness type application or schedule type application, the display mode of the dynamic mode of the icon of the application may be preset to be a countdown mode.

As an example, a display mode of the dynamic mode of the icon of the application may be further determined according to the preset time. Specifically, the display mode of the dynamic mode of the icon of the application within a preset time may be preset. For example, for the application, the display mode may be set with respect to each of one or more time periods, respectively.

As an example, the display mode of the dynamic mode of the icon of the application may be further determined according to a predetermined event. The event may include at least one of a system event and events occurred in the application. Here, the association relationship between the predetermined event and the display mode may be preset, and then the display mode of the dynamic mode of the icon of the application is determined according to the occurred event and the association relationship. For example, an event of the user subscribing a push of a certain application may be associated with the push mode among the display modes; an event of the user participating in limited time discount sales in a certain application is associated with the countdown mode among the display modes and the like. Correspondingly, in step S20, the display mode of the dynamic mode of the icon of the application may be determined by detecting an event that occurred, determining whether a display mode associated with the occurred event exists among the display modes of the dynamic mode of the icon of the application, and determining the display mode associated with the occurred event as the display mode of the dynamic mode of the icon of the application.

As an example, the display mode of the dynamic mode of the icon of the application may be further determined according to the selection operation of the user for the display mode. FIG. 3 illustrates a setting interface of a display mode of a dynamic mode of an icon of an application according to an exemplary embodiment of the present disclosure. A widget for entering a setting interface diagram of the display mode of the dynamic mode of the icon of each application may be set with respect to each application in the dynamic mode setting interface of the icon of the application as illustrated in FIG. 2. After the user operates the widget, the icon of the application enters the setting interface of the display mode as illustrated in FIG. 3. The user may set the display mode of the dynamic mode of the icon of the application in the setting interface diagram of the display mode. In FIG. 3, the user sets the display mode of the dynamic mode of the icon of the WeChat application to be a message reminder mode.

In step S30, information corresponding to the determined display mode is acquired. Here, messages corresponding to different display modes are different.

Information corresponding to the message reminder mode may include various real-time messages. The real-time messages are various notification type messages sent by the application with respect to users. For example, for social type applications (for example, a call application, a short message application, a WeChat application, a QQ application, a mail application and the like), the real-time messages may be unread information, missed calls, unread mails and so on; for traffic type applications, the real-time messages may be vehicle arrival information; for logistics type applications, the real-time messages may be logistics change information; for finance type applications, the real-time messages may be real-time consumption information; and for navigation type applications, the real-time messages may be navigation information. In addition, the information corresponding to the message reminder mode may further include progress information, for example, a song play progress in music type applications, a recording time of sound recording type applications, a download progress of downloading type applications and the like.

Information corresponding to the push mode includes push messages. The push messages are various information type messages pushed by application service providers to users. For example, the push messages may be news, version update notifications, sale promotion messages, weather change messages, pushes subscribed by users and the like.

Information corresponding to the countdown mode includes time reminder information. The time reminder information are various time reminder information in an application and include time reminder information automatically generated by the application and time reminder information set by a user with respect to the application. For example, time reminder information include at least one of a current time, a purpose reminder time, a time length lasted by countdown (that is, how long time is it before the purpose reminder time to start the countdown), a countdown time (that is, a difference between the purpose reminder time and the current time) and the like. It should be understood that the time reminder information of the present disclosure is not limited hereto and may also be other forms of time reminder information.

For example, for fitness type application, the time reminder information automatically generated by the application may be a fitness countdown time generated according to user setting or fitness habits of the user; for game type, shopping type, schedule type or recreation and entertainment type applications, the time reminder information automatically generated by the application may be a countdown time before a certain activity or program starts; and for finance type applications, the time reminder information automatically generated by the application may be a countdown time of number of days of credit card payment.

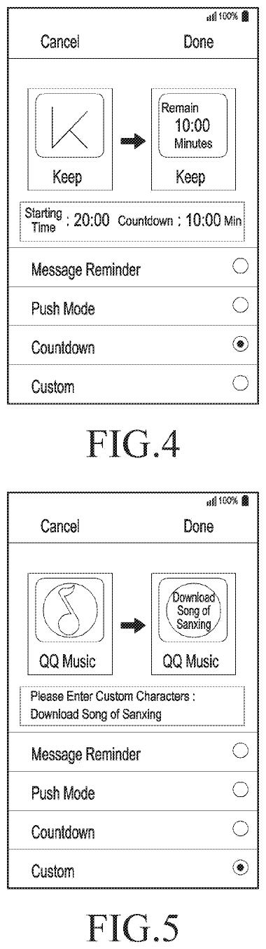

For the time reminder information set by the user with respect to an application, a setting interface for a user to set time reminder information with respect to the application may be provided. FIG. 4 illustrates a setting interface for a user to set time reminder information with respect to an application according to an exemplary embodiment of the present disclosure. Here, in the setting interface of the display mode of the dynamic mode of the icon of the application as illustrated in FIG. 3, after the user selects the countdown mode, the setting interface for a user to set time reminder information with respect to the application as illustrated in FIG. 4 is entered, and in the interface as illustrated in FIG. 4, the user may input the time when time reminder starts and the time length lasted by the countdown. In FIG. 4, the user sets the purpose reminder time of the application “Keep” to be 20:00 and sets the time length lasted by the countdown to be 10 minutes.

Information corresponding to the custom mode includes the content set by the user with respect to the application. The content set by the user with respect to the application may include text, picture and so on. Here, a setting interface for the user to set the content with respect to the application may be provided. FIG. 5 illustrates a setting interface for a user to set content with respect to an application according to an exemplary embodiment of the present disclosure. Here, in the setting interface of the display mode of the dynamic mode of the icon of the application as illustrated in FIG. 3, after the user selects the custom mode, the setting interface for a user to set the content with respect to the application as illustrated in FIG. 5 is entered, and in the interface as illustrated in FIG. 5, the user may input the content set with respect to the application. In FIG. 5, the user sets the content set with respect to the QQ music application to be “download Song of Sanxing”.

In step S40, the information is displayed on the icon of the application. Specifically, the information may be displayed on the icon of the application on the desktop. Here, the background of the icon of the application may use a preset picture, or the original display picture is used as the background of the icon after the color is lightened or transparent, and the acquired information is displayed on the background again.

Here, various display manners may be employed to display the acquired information on the icon of the application. For example, the acquired information may be displayed in different colors, different fonts or at different positions. Here, with respect to different display modes, the display manners in which the information is displayed on the icon of the application may be set to be the same. With respect to different display modes, the display manners in which the information is displayed on the icon of the application may be set to be different, that is, the information is displayed on the icon of the application in the determined display mode. In addition, the display manner may also be related to the application. In other words, in step S40, the display manner may be determined according to the determined display mode or according to the determined display mode and the application, and the information is displayed on the icon of the application in the determined display manner.

Since the display space on the icon of the application is limited and the number of information that may need to be displayed is large, in step S40, the latest acquired predetermined number of information may be displayed on the icon of the application, or all of the acquired information are displayed by automatically scrolling, or all of the acquired information are displayed by scrolling according to the user's operation.

In addition, since the display space on the icon of the application is limited, in step S40, a key content of the acquired information may be extracted and the key content is displayed on the icon of the application. For example, an avatar of a contact whose information is unread may be used as a key content, and a key word in a push message is used as a key content to be displayed on the corresponding icon of the application.

In addition, in order to facilitate the user to view the information displayed on the icon, the method may further enlarge-display the icon according to the operation of the user for the icon or preview the information. Correspondingly, the method may further include: receiving a first predetermined operation performed on the icon of the application, and in response to the first predetermined operation, enlarge-displaying the icon of the application or previewing the information displayed on the icon of the application. The first predetermined operation may be various operations performed by the user on the icon, such as a single click, a long press and so on.

Here, when the information displayed on the icon of the application is a plurality of pieces, the latest acquired information may be previewed, or all of the displayed information may be previewed in an automatically scrolling manner, or all of the displayed information may be previewed in a scrolling manner according to the user's operation.

Here, in the preview state, in order to facilitate the user to operate the previewed information, a widget for processing the previewed information may be further displayed. For example, a widget for the processes of deleting, replying, marking as read and the like, of the previewed information is displayed, and the previewed information is correspondingly processed after the user operates the widget.

Here, in the preview state, in order to facilitate the user to view the previewed information in detail, the application is entered according to the operation performed by the user on the previewed information to view the previewed information. Correspondingly, the method may further include: receiving a second predetermined operation performed on the previewed information, and in response to the second predetermined operation, entering the application to view the previewed information. The second predetermined operation may be various operations performed by the user on the previewed information, such as a single click, a long press and so on.

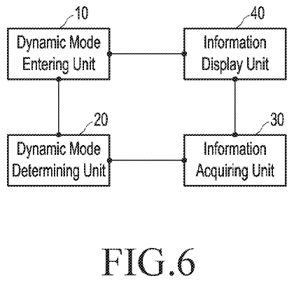

FIG. 6 is a block diagram illustrating a display apparatus of an icon of an application according to an exemplary embodiment of the present disclosure. The display apparatus of an icon of an application according to an exemplary embodiment of the present disclosure may be applicable to various terminals which may display application icons, for example, a smart phone, a personal computer, a tablet computer, a game console, a digital multimedia player and the like. As illustrated in FIG. 6, a display apparatus of an icon of an application according to an exemplary embodiment of the present disclosure includes a dynamic mode entering unit 10, a display mode determining unit 20, an information acquiring unit 30 and an information display unit 40.

The dynamic mode entering unit 10 enables the icon of the application to enter the dynamic mode. After the icon of the application according to an exemplary embodiment of the present disclosure enters the dynamic mode, the content displayed by the icon of the application may change.

Here, the icon of the application may be enabled to enter the dynamic mode according to an operation of the user or occurrence of a predetermined event.

As an example, the dynamic mode entering unit 10 may receive a first setting operation of setting an icon of an application to the dynamic mode, and the icon of the application is set to the dynamic mode in response to the first setting operation. FIG. 2 illustrates a dynamic mode setting interface of an icon of an application according to an exemplary embodiment of the present disclosure. For example, a widget for entering the dynamic mode setting interface may be set in the system setting interface of the terminal. After the user operates the widget for entering the dynamic mode setting interface, the dynamic mode setting interface of the icon of the application as illustrated in FIG. 2 is entered. As illustrated in FIG. 2, a switch 201 for entering and exiting the dynamic mode is provided for each application in the dynamic mode setting interface. When the switch 201 is in an off state, the user may click the switch 201 to enable the switch 201 to enter a on state, thereby making the icon of the application corresponding to the switch 201 enter the dynamic mode. In FIG. 2, the user turns on the switches 201 of a weather application, a message application and an S calendar application, and the above three icons of applications are in the dynamic mode.

As an example, the dynamic mode entering unit 10 may further set the icon of the application to the dynamic mode in response to a predetermined event. For example, an icon of a predetermined application may be set to the dynamic mode in response to a boot event. For example, the icon of the application may also be set to the dynamic mode in response to the application being run. For example, the icon of the application may be further set to the dynamic mode in response to a predetermined function of the application being executed (for example, a message push function of a certain application is turn on). For example, the icon of the application may be further set to the dynamic mode in response to a predetermined operation in the application being executed (for example, for participating in an activity of snapping up a mobile phone in a certain shopping application).

The display mode determining unit 20 determines a display mode of the dynamic mode of the icon of the application. Here, the display mode may be used to determine a type and a specific display manner of information displayed in the icon of the application. In one embodiment, the display mode may include at least one of a message reminder mode, a push mode, a countdown mode and a custom mode. However, the present disclosure is not limited to hereto, and other display modes are also implementable.

Here, the display mode determining unit 20 may determine the display mode through various manners. For example, the display mode determining unit 20 may determine a display mode of the dynamic mode of the icon of the application according to a preset value of the display mode, a preset time, a predetermined event or a selection operation of the user for the display mode.

As an example, the display mode determining unit 20 may determine a display mode of the dynamic mode of the icon of the application according to the preset value of the display mode of the icon of the application. Here, the preset value of the display mode is used for indicating the display mode. In other words, the display mode is determined according to the display mode indicated by the preset value of the display mode that is preset with respect to the application. For example, the display mode of the dynamic mode of the icon of the application may be preset according to a type of the application. For example, for social type application (for example, a call application, a short message application, a WeChat application, a QQ application, a mail application and the like), the display mode of the dynamic mode of the icon of the application may be preset to be a message reminder mode; for news and information type application or shopping type application, the display mode of the dynamic mode of the icon of the application may be preset to be a push mode; and for fitness type or schedule type applications, the display mode of the dynamic mode of the icon of the application of the type may be preset to be a countdown mode.

As an example, the display mode determining unit 20 may further determine a display mode of the dynamic mode of the icon of the application according to the preset time. Specifically, the display mode of the dynamic mode of the icon of the application within a preset time may be preset. For example, for the application, the display mode may be set with respect to each of one or more time periods, respectively.

As an example, the display mode determining unit 20 may further determine a display mode of the dynamic mode of the icon of the application according to the predetermined event. The event may include at least one of a system event and events occurred in the application. Here, the association relationship between the predetermined event and the display mode may be preset, and then the display mode of the dynamic mode of the icon of the application is determined according to the occurred event and the association relationship. For example, an event of the user subscribing a push of a certain application may be associated with the push mode among the display modes; an event of the user participating in limited time discount sales in a certain application is associated with the countdown mode among the display modes and the like. Correspondingly, the display mode determining unit 20 may determine the display mode of the dynamic mode of the icon of the application by detecting an event that occurred, determining whether a display mode associated with the occurred event exists among the display modes of the dynamic mode of the icon of the application, and determining the display mode associated with the occurred event to be the display mode of the dynamic mode of the icon of the application.

As an example, the display mode determining unit 20 may further determine the display mode of the dynamic mode of the icon of the application according to the selection operation of the user for the display mode. FIG. 3 illustrates a setting interface of a display mode of a dynamic mode of an icon of an application according to an exemplary embodiment of the present disclosure. A widget for entering a setting interface diagram of the display mode of the dynamic mode of the icon of each application may be set with respect to each application in the dynamic mode setting interface of the icon of the application as illustrated in FIG. 2. After the user operates the widget, the icon of the application enters the setting interface of the display mode as illustrated in FIG. 3. The user may set the display mode of the dynamic mode of the icon of the application in the setting interface diagram of the display mode. In FIG. 3, the user sets the display mode of the dynamic mode of the icon of the WeChat application to be a message reminder mode.

The information acquiring unit 30 acquires information corresponding to the determined display mode. Here, messages corresponding to different display modes are different.

Information corresponding to the message reminder mode may include various real-time messages. The real-time messages are various notification type messages sent by the application with respect to users. For example, for social type applications (for example, a call application, a short message application, a WeChat application, a QQ application, a mail application and the like), the real-time messages may be unread information, missed calls, unread mails and so on; for traffic type applications, the real-time messages may be vehicle arrival information; for logistics type applications, the real-time messages may be logistics change information; for finance type applications, the real-time messages may be real-time consumption information; and for navigation type applications, the real-time messages may be navigation information. In addition, the information corresponding to the message reminder mode may further include process information, for example, a song play process in music type applications, a recording time of sound recording type applications, a download process of downloading type applications and the like.

Information corresponding to the push mode includes push messages. The push messages are various information type messages pushed by application service providers to users. For example, the push messages may be news, version update notifications, sale promotion messages, weather change messages, pushes subscribed by users and the like.

Information corresponding to the countdown mode includes time reminder information. The time reminder information are various time reminder information in the application and include time reminder information automatically generated by an application and time reminder information set by a user with respect to the application. For example, time reminder information include at least one of a current time, a purpose reminder time, a time length lasted by countdown (that is, how long time is it before the purpose reminder time to start the countdown), a countdown time (that is, a difference between the purpose reminder time and the current time) and the like. It should be understood that the time reminder information of the present disclosure is not limited hereto and may also be other forms of time reminder information.

For example, for fitness type application, the time reminder information automatically generated by the application may be a fitness countdown time generated according to user setting or fitness habits of the user; for game type, shopping type, schedule type or recreation and entertainment type applications, the time reminder information automatically generated by the application may be a countdown time before a certain activity or program starts; and for finance type applications, the time reminder information automatically generated by the application may be a countdown time of number of days of credit card payment.

For the time reminder information set by the user with respect to an application, a setting interface for a user to set time reminder information with respect to the application may be provided. FIG. 4 illustrates a setting interface for a user to set time reminder information with respect to an application according to an exemplary embodiment of the present disclosure. Here, in the setting interface of the display mode of the dynamic mode of the icon of the application as illustrated in FIG. 3, after the user selects the countdown mode, the setting interface for a user to set time reminder information with respect to the application as illustrated in FIG. 4 is entered, and in the interface as illustrated in FIG. 4, the user may input the time when time reminder starts and the time length lasted by the countdown. In FIG. 4, the user sets the purpose reminder time of the application “Keep” to be 20:00 and sets the time length lasted by the countdown to be 10 minutes.

Information corresponding to the custom mode includes the content set by the user with respect to the application. The content set by the user with respect to the application may include text, picture and so on. Here, a setting interface for the user to set the content with respect to the application may be provided. FIG. 5 illustrates a setting interface for a user to set content with respect to an application according to an exemplary embodiment of the present disclosure. Here, in the setting interface of the display mode of the dynamic mode of the icon of the application as illustrated in FIG. 3, after the user selects the custom mode, the setting interface for a user to set the content with respect to the application as illustrated in FIG. 5 is entered, and in the interface as illustrated in FIG. 5, the user may input the content set with respect to the application. In FIG. 5, the user sets the content set with respect to the QQ music application to be “download Song of Sanxing”.

The information display unit 40 displays the information on the icon of the application. Specifically, the information display unit 40 may display the information on the icon of the application on the desktop. Here, the background of the icon of the application may use a preset picture, or the original display picture is used as the background of the icon after the color is lightened or transparent, and the acquired information is displayed on the background again.

Here, the information display unit 40 may display the acquired information on the icon of the application by employing various display manners. For example, the acquired information may be displayed in different colors, different fonts and at different positions. Here, with respect to different display modes, the display manners in which the information is displayed on the icon of the application may be set to be the same. With respect to different display modes, the display manners in which the information is displayed on the icon of the application may be set to be different, that is, the information is displayed on the icon of the application in the determined display mode. In addition, the display manner may also be related to the application. In other words, the information display unit 40 may determine the display manner according to the determined display mode or according to the determined display mode and the application, and the information is displayed on the icon of the application in the determined display manner.

Since the display space on the icon of the application is limited and the number of information that may need to be displayed is large, the information display unit 40 may display the latest acquired predetermined number of information on the icon of the application, or automatically scroll to display all of the acquired information, or scroll to display all of the acquired information according to the user's operation.

In addition, since the display space on the icon of the application is limited, the information display unit 40 may extract a key content of the acquired information and display the key content on the icon of the application. For example, an avatar of a contact whose information is unread may be used as a key content, and a key word in a push message is used as a key content to be displayed on the corresponding icon of the application.

In addition, in order to facilitate the user to view the information displayed on the icon, the apparatus may also enlarge-display the icon according to the operation of the user for the icon or preview the information. Correspondingly, the apparatus may further include a preview unit (not shown). The preview unit receives a first predetermined operation performed on the icon of the application, and in response to the first predetermined operation, enlarge-displays the icon of the application or previews the information displayed on the icon of the application. The first predetermined operation may be various operations performed by the user on the icon, such as a single click, a long press and so on.

Here, when the information displayed on the icon of the application is a plurality of pieces, the latest acquired information may be previewed, or all of the displayed information may be previewed in an automatically scrolling manner, or all of the displayed information may be previewed in a scrolling manner according to the user's operation.

Here, in the preview state, in order to facilitate the user to operate the previewed information, the preview unit may further display a widget for processing the previewed information. For example, a widget for the processes of deleting, replying, marking as read and the like, of the previewed information is displayed, and the previewed information is correspondingly processed after the user operates the widget.

Here, in the preview state, in order to facilitate the user to view the previewed information in detail, the application is entered according to the operation performed by the user on the previewed information to view the previewed information. Correspondingly, the apparatus may further include an application entering unit (not shown). The application entering unit receives a second predetermined operation performed on the previewed information, and in response to the second predetermined operation, enters the application to view the previewed information. The second predetermined operation may be various operations performed by the user on the previewed information, such as a single click, a long press and so on.

According to the display method and apparatus of an icon of an application of the exemplary embodiments of the present disclosure, after the icon of the application enters the dynamic mode, a display space of the icon of the application may be sufficiently utilized by acquiring the information corresponding to the display mode of the dynamic mode and displaying the acquired information on the icon of the application, to facilitate the user's viewing on the information of the application.

It should be understood that the display method of an icon of an application according to the present disclosure may also be implemented as computer readable codes on a computer readable recording medium. The computer readable recording medium is an arbitrary data storage device that may store data which are read thereafter by a computer system. Examples of the computer readable recording medium include a Read-Only Memory (ROM), a Random-Access Memory (RAM), a CD-ROM, a magnetic tape, a floppy disk, an optical data storage device and a carrier (such as data transmission through the Internet via a wired or wireless transmission path). The computer readable recording medium may also be distributed over a computer system connected to the Internet, so that the computer readable codes are stored and executed in a distributed fashion. In addition, functional programs, codes and code segments to accomplish the present disclosure may be easily explained by ordinary programmers in the art related to the present disclosure within a range of the present disclosure.

In addition, respective units in the display apparatus of an icon of an application according to an exemplary embodiment of the present disclosure may be completely implemented by hardware, for example, Field Programmable Gate Array (FPGA) or Application Specific Integrated Circuit (ASIC); may further be implemented in a way of combining hardware with software; and may also be completely implemented through a computer program in a software manner.

While the present disclosure has been particularly shown and described with reference to exemplary embodiments thereof, it should be understood by those skilled in the art that various changes in form and details may be made therein without departing from the spirit and scope of the present disclosure as defined by the following claims.

What is claimed is:

1. A display method of an icon of an application, comprising:
A) enabling the icon of the application to enter a dynamic mode;
B) determining a display mode of the dynamic mode of the icon of the application;
C) acquiring information corresponding to the determined display mode; and
D) displaying the information on the icon of the application.

2. The method of claim 1, wherein step D) comprises: displaying the information on the icon of the application in the determined display mode.

3. The method of claim 2, wherein step D) comprises: determining a display manner according to the determined display mode or according to the determined display mode and the application, and displaying the information on the icon of the application in the determined display manner.

4. The method of claim 1, wherein step A) comprises: receiving a first setting operation of setting the icon of the application to a dynamic mode and setting the icon of the application to the dynamic mode in response to the first setting operation; or setting the icon of the application to the dynamic mode in response to a predetermined event.

5. The method of claim 1, wherein step B) comprises: determining the display mode of the dynamic mode of the icon of the application according to a preset value of the display mode, a preset time and a predetermined event or a selection operation of a user for the display mode.

6. The method of claim 5, wherein the determining of the display mode of the dynamic mode of the icon of the application according to the predetermined event comprises:
detecting an event that occurred;
determining whether a display mode associated with the occurred event exists among display modes of the dynamic mode of the icon of the application; and
determining the display mode associated with the occurred event as the display mode of the dynamic mode of the icon of the application.

7. The method of claim 6, wherein the event comprises at least one of a system event and an event occurred in the application.

8. The method of claim 5, wherein the display mode comprises at least one of a message reminder mode, a push mode, a countdown mode and a custom mode; information corresponding to the message reminder mode comprises a real time message; information corresponding to the push mode comprises a push message; information corresponding to the countdown mode comprises time reminder information; and information corresponding to the custom mode comprises the content set by the user for the application.

9. The method of claim 1, wherein in step D), latest acquired predetermined number of information are displayed, or all of the acquired information are displayed by automatically scrolling, or all of the acquired information are displayed by scrolling according to the user's operation, on the icon of the application.

10. The method of claim 1, wherein step D) comprises: extracting a key content of the acquired information and displaying the key content on the icon of the application.

11. The method of claim 10, further comprising: E) receiving a first predetermined operation performed on the icon of the application, and in response to the first predetermined operation, enlarge-displaying the icon of the application or previewing the information displayed on the icon of the application, wherein when the information displayed on the icon of the application is a plurality of pieces, latest acquired information is previewed, or all of displayed information are previewed in an automatically scrolling manner, or all of displayed information are previewed in a scrolling manner according to the user's operation.

12. The method of claim 11, wherein step E) further comprises displaying a widget for processing the previewed information.

13. The method of claim 11, further comprising: F) receiving a second predetermined operation performed on the previewed information, and in response to the second predetermined operation, entering the application to view the previewed information.

14. A display apparatus of an icon of an application, comprising:
a dynamic mode entering unit to enable the icon of the application to enter a dynamic mode;
a display mode determining unit to determine a display mode of the dynamic mode of the icon of the application;
an information acquiring unit to acquire information corresponding to the determined display mode; and
an information display unit to display the information on the icon of the application.
